(19) United States
(12) Patent Application Publication
(10) Pub. No.: US 2016/0134953 A1
(43) Pub. Date: May 12, 2016

(54) SHARED PROTECTION IN OPTICAL NETWORKS

(71) Applicant: Broadcom Corporation, Irvine, CA (US)

(72) Inventor: Glen KRAMER, Petaluma, CA (US)

(21) Appl. No.: 14/940,053

(22) Filed: Nov. 12, 2015

Related U.S. Application Data
(60) Provisional application No. 62/078,928, filed on Nov. 12, 2014.

(51) Int. Cl. H04Q 11/00

(52) U.S. Cl. CPC H04Q 11/0067; H04Q 2011/0081; H04Q 2011/0086

(57) ABSTRACT

A device for shared protection in an optical network may include a processor circuit. The processor circuit may be configured to transmit optical signals over an optical network port to a first set of optical network units (ONUs), receive an indication that an optical line terminal (OLT) is unavailable to service a second set of ONUs, transition to a protection operation mode from a normal operation mode in response to indication, and transmit optical signals over the optical network port to the first and second set of ONUs. The optical signals may include resource allocation information for at least some of the first and second set of ONUs. The device may operate as a working OLT for the first set of ONUs when in the normal operation mode. The device may operate as the working OLT for the first and second set of ONUs when in the protection operation mode.

### CROSS-REFERENCE TO RELATED APPLICATIONS

The present application claims the benefit of U.S. Provisional Patent Application Ser. No. 62/078,928, entitled “Shared Protection in Optical Networks,” filed on Nov. 12, 2014, which is hereby incorporated by reference in its entirety for all purposes.

### TECHNICAL FIELD

The present description relates generally to optical networks, and more particularly, but not exclusively, to shared protection in optical networks.

### BACKGROUND

Passive Optical Networks (PONs), such as Ethernet Passive Optical Networks (EPONs), are increasingly being deployed to satisfy the growth in residential and commercial demand for bandwidth intensive services, e.g., broadband internet access. An EPON generally includes optical line terminal (OLT) equipment in a central office and multiple optical network units (ONUs) in the field, that are all connected by a passive optical connection. The ONUs may each couple customer premises equipment of one or more residential or commercial subscribers to the EPON, such that the subscribers may receive bandwidth intensive services, while the OLT equipment may provide flow classification, modification, and quality of service functions for the entire EPON. In one or more implementations, the OLT equipment may be coupled to a backplane or other uplink, such as through an Internet Service Provider (ISP).

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example of a network environment in which a system for shared protection in an optical network may be implemented in accordance with one or more implementations.

FIG. 2 illustrates an example of a network environment in which a system for shared protection in an optical network may be implemented in accordance with one or more implementations.

FIG. 3 illustrates a flow diagram of an example process of an optical line terminal in a system for shared protection in accordance with one or more implementations.

FIG. 4 illustrates an example of a network environment in which a system for shared protection in an optical network may be implemented in accordance with one or more implementations.

FIG. 5 conceptually illustrates an example electronic system with which one or more implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology.

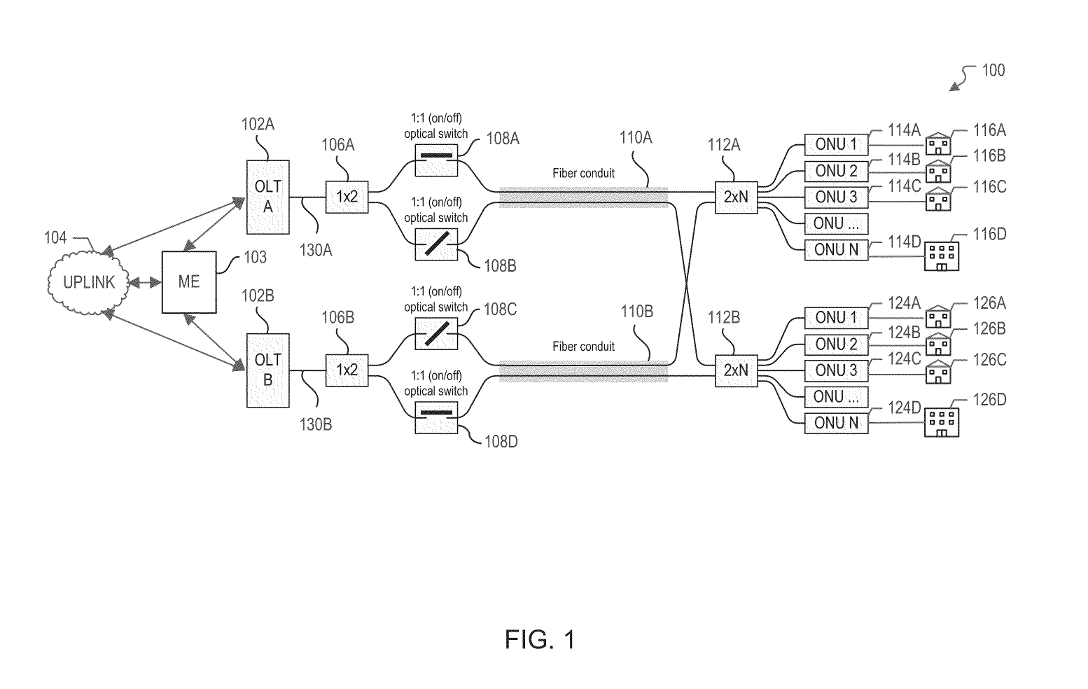

FIG. 1 illustrates an example of a network environment 100 in which a system for shared protection in an optical network may be implemented in accordance with one or more implementations. Not all of the depicted components may be used, however, and one or more implementations may include additional components not shown in the figure. Variations in the arrangement and types of the components may be made without departing from the spirit or scope of the claims as set forth herein. Additional, different, or fewer components may be provided.

The network environment 100 includes a passive optical network (PON) environment, such as an Ethernet passive optical network (EPON), a broadband passive optical network (BPON), a gigabit passive optical network (GPON), or generally any PON. For example, in an EPON, data traffic is encapsulated in Ethernet frames as defined in the Institute of Electrical and Electronics Engineers (IEEE) 802.3 standard. The network environment 100 includes optical line terminals (OLTs) 102A-B, a management entity (ME) 103, an uplink 104, splitters 106A-B and 112A-B, optical switches 108A-B, such as 1×1 (On/Off) optical switches, conduits 110A-B, optical network units (ONUs) 114A-D and 124A-D, and customer premises equipment 116A-D and 126A-D.

The network environment 100 includes a first PON, a second PON, a third PON, and a fourth PON. The first PON includes the our 102A, the ONUs 114A-D, and a first optical distribution network (ODN). The first ODN may be utilized to facilitate communication of optical signals between the OLT 102A and the ONUs 114A-D. The first ODN may include the splitters 106A and 112A, the optical switch 108A, the conduit 110A, interconnections between these components, and interconnections between these components and one of the OLT 102A or the ONUs 114A-D. The second PON includes the OLT 102A, the ONUs 124A-D, and a second ODN. The second ODN may be utilized to facilitate communication of optical signals between the OLT 102A and the ONUs 124A-D. The second ODN may include the splitters 106A and 112B, the optical switch 108B, the conduit 110B, interconnections between these components, and interconnections between these components and one of the OLT 102A or the ONUs 124A-D.

The third PON includes the OLT 102B, the ONUs 114A-D, and a third ODN. The third ODN may be utilized to facilitate communication of optical signals between the OLT 102B and the ONUs 114A-D. The third ODN may include the splitters 106B and 112A, the optical switch 108C, the conduit 110B, interconnections between these components, and interconnections between these components and one of the OLT 102B or the ONUs 114A-D. The fourth PON includes the OLT 102B, the ONUs 124A-D, and a fourth ODN. The fourth ODN may be utilized to facilitate communication of optical signals between the OLT 102B and the ONUs 124A-D. The fourth ODN may include the splitters 106B and 112B, the optical switch 108D, the conduit 110B, interconnections between these components, and interconnections between these components and one of the OLT 102B or the ONUs 124A-D.

The first, second, third, and fourth PONs may include additional, different, and/or fewer components than those shown in FIG. 1, such as additional switches, splitters, and/or other optical routing devices. For discussion purposes, the first, second, third, and fourth ODNs utilize tree topologies to propagate optical signals from/to the OLTs 102A-B, ONUs 114A-D, and ONUs 124A-D. However, other topologies such as ring topologies, bus topologies, among others, may be utilized. Between any two components of the PONs (e.g., between the optical switch 108A and the splitter 112A, between the splitter 106B and the OLT 102B), one or more waveguides (e.g., optical waveguides, optical fibers) may be utilized to guide optical signals along an optical propagation path to facilitate communication between an OLT (e.g., the OLT 102A) and its associated ONUs (e.g., the ONUs 114A-D). In FIG. 1, the waveguides are represented by solid lines between these components. The conduits 110A-B may be, or may include, one or more waveguides (e.g., optical waveguides, optical fibers) and/or any other component that facilitates propagation of optical signals. In some cases, the waveguides may be, or may include, single-mode optical fibers.

In one or more implementations, the first and second ODNs overlap and/or the third and fourth ODNs overlap. The first and second ODNs may include a merged portion 130A that is shared by the first and second ODNs. The third and fourth ODNs may include a merged portion 130B that is shared by the third and fourth ODNs. The merged portion 130A may be, may include, or may be a part of, an optical waveguide (e.g., optical cable, optical fiber) coupled to an optical network port of the OLT 102A and the splitter 106A. The merged portion 130B may be, may include, or may be a part of an optical waveguide coupled to an optical network port of the our 102B and the splitter 106B.

The ME 103 may be, may include, may be a part of or may be in communication with one or more controller/monitoring device(s) of the network environment 100. The ME 103 (or the controller/monitoring device(s)) may monitor status of the OLTs 102A-B and the various components of the ODNs. The ME 103 may generate and propagate control signals based on the status. The ME 103 may also be referred to as the network management system (NMS). Although the ME 103 is illustrated as a single component in FIG. 1, the ME 103 may include multiple management devices of the network environment 100 and/or the ME 103 may be included in the OLT 102A and/or the OLT 102B. The management devices may be distributed, either logically or physically, throughout the network environment 100.

The ONUs 114A-D and 124A-D may be located at, or within a proximity of, e.g. within several miles of, the associated customer premises equipment 116A-D and 126A-D. The ONUs 114A-D and 124A-D may transform incoming optical signals from an OLT (e.g., one of the OLTs 102A-B) into electrical signals that are used by networking and/or computing equipment at the associated customer premises equipment 116A-D and 126A-D. The ONUs 114A-D and 124A-D may each service a single customer or multiple customers at the associated customer premises equipment 116A-D and 126A-D. The ONUs 114A-D and 124A-D are each associated with at least one logical link identifier (LLID). Although FIG. 1 illustrates the OLTs 102A-B as each being associated with five or more ONUs, the OLTs 102A-B may be associated with more or fewer than five ONUs.

The LLIDs may be assigned to the ONUs by the associated OLT and/or the ME 103. For example, the OLT 102A may assign LLIDs to the ONUs 114A-D, such as during a discovery procedure. In some cases, overlap is avoided between LLIDs assigned to the ONUs 114A-D and the ONUs 124A-D. To avoid overlap across all LLIDs assigned by the OLTs 102A-B, the ONUs 114A-D and 124A-D may be assigned LLIDs by the ME 103. In some cases, the OLTs 102A and 102B are each allocated (e.g., by the ME 103) a respective non-overlapping pool of LLIDs from which they can select and assign LLIDs to the ONUs 114A-D and 124A-D, respectively. Alternatively or in addition, the ME 103 and/or the OLTs 102A-B may store a list of all LLIDs that have been assigned and the ME 103 and/or the OLTs 102A-B may assign LLIDs not on the list to newly discovered ONUs.

The customer premises equipment 116A-D and 126A-D represent at least a portion of residential and/or commercial properties that are connected to the uplink 104 through the ONUs 114A-D and 124A-D, the ODNs, and/or the OLTs 102A-B. A customer premises equipment (e.g., the customer premises equipment 116A) may include one or more electronic devices, such as laptop or desktop computers, smartphones, personal digital assistants (PDAs), portable media players, set-top boxes, tablet computers, televisions or other displays with one or more processors coupled thereto and/or embedded therein, and/or any other devices that include, or are coupled to, a network interface. The customer premises equipment may be associated with, and/or may include, networking devices, such as home gateways, routers, switches, and/or any other networking devices, that may interface with, and/or be communicatively coupled to, the associated ONU (e.g., the ONU 114A). One or more of the networking devices associated with a customer premises equipment (e.g., the customer premises equipment 116A) may interface with the associated ONU external to the customer premises equipment, such as several miles from the customer premises equipment. In this instance, the networking devices may be connected to the customer premises equipment via, e.g., copper technologies, such as wired Ethernet.

In one or more implementations, the uplink 104 may be a connection from a chassis of the OLT 102A and/or the OLT 102B to aggregating switches in a central office or directly to metropolitan networks. In some cases, the OLT chassis may include multiple line cards, with each line card including multiple OLT ports. By way of non-limiting example, the OLT chassis may include 12-14 line cards each with 4-8 OLT ports. The line cards may be connected via backplane to a switch. An uplink rate from the switch may be N×10 gigabits per second (G), such as 40 gigabits per second (40 G) or 100 gigabits per second (100 G) by way of non-limiting example. One OLT chassis may be utilized to serve many thousands of users. The uplink 104 may also include, but is not limited to, any one or more of the following network topologies, including a bus network, a star network, a ring network, a mesh network, a star-bus network, a tree or hierarchical network, and the like. The uplink 104 may be connected to the OLTs 102A-B via network-to-network interface (NNIs).

The OLTs 102A-B may be located in central offices, such as a central office of a service provider. In some aspects, the OLTs 102A-B may be on the same or on different line cards. The OLTs 102A-B provide an interface between their associated ONUs (e.g., the ONUs 114A-D) and the uplink 104, such as by transforming between the optical signals used by the associated ONUs and the electrical signals used by the uplink 104. The OLTs 102A-B may support multiple upstream and downstream data rates, such as 1 gigabit per second (1 G), 10 gigabits per second (10 G), and/or any other transmission rates. The OLTs 102A-B may include one or more ports that may transmit data to, and receive data from, the associated ONUs, with each port being coupled to an ODN. For example, the OLT 102A may utilize the one or more ports to transmit data to, and receive data from, one or more ONUs 114A-D and 124A-D at one of the data rates supported by the OLT 102A, such as 1 Gbit/s (1 G), 10 Gbit/s (10 G), etc. In one or more implementations, the OLTs 102A-C and/or one or more of the ONUs 114A-D and 124A-D may support any Ethernet-based PON system and/or any bit rate, such as 1 G, 10 G, and higher.

The splitters 106A-B may be splitters that include at least one port for receiving optical signals from and/or transmitting optical signals to an OLT (e.g., the OLTs 102A-B), and at least two ports for receiving optical signals from and/or transmitting optical signals to a conduit that is in optical communication with ONUs. For example, the splitters 106A-B may be 1×2 splitters. The splitter 106A splits downstream optical signals from the OLT 102A such that nominally the same downstream optical signals are routed to each of the optical switches 108A-B. In this regard, the downstream optical signals that are routed to each of the optical switches 108A-B have the same information content as the downstream optical signals from the OLT 102A, but at a reduced power level relative to the downstream optical signals from the OLT 102A. In the case of a 3-dB optical splitter, the downstream optical signals in routed to each of the optical switches 1082A-B have the same information content but has a power level that is nominally half the power level of the downstream optical signals from the OLT 102A. Similarly, the splitter 106B splits downstream optical signals from the OLT 102B such that nominally the same downstream optical signals (e.g., same information content as, but reduced power level from, the downstream optical signals from the OLT 102B) are routed to each of the optical switches 108C-D.

For upstream signals from the ONUs, the splitter 106A may merge the upstream signals propagating one path through the optical switch 108A and the upstream signals propagating another path through the optical switch 108B into a single path through the merged portion 130A. The splitter 106B may merge the upstream signals propagating one path through the optical switch 108C and the upstream signals propagating another path through the optical switch 108D into a single path through the merged portion 130B.

The splitter 112A splits downstream optical signals from an OLT (e.g., the OLTs 102A-B) such that nominally the same downstream optical signals are routed to each of the ONUs 114A-D. The splitter 112B splits downstream optical signals such that nominally the same downstream optical signals from the OLT are routed to each of the ONUs 124A-D. The splitter 112A may receive upstream optical signals from the ONUs and facilitate routing of the upstream optical signals to the conduits 110A-B. The splitter 112B may receive upstream optical signals from the ONUs and facilitate routing of the upstream optical signals to the conduits 110A-B. The splitters 106A-B may be 2×N splitters. The splitters 106A-B and 112A-B may be, may include, or may be a part of Mach-Zehnder interferometer-based splitters.

The optical switches 108A-D may each be in an on state (e.g., closed state, activated state) or an off state (e.g., open state, non-activated state). The actuation/control mechanism (not shown) for the optical switches 108A-D may be mechanical, electrical, thermal, solid-state, etc. The optical switches 108A-D may be 1×1 optical switches. In the on state, the optical switches 108A-D may be utilized to allow optical signals to pass through the optical switches 108A-D. In the off state, the optical switches 108A-D may be utilized to prevent optical signals from passing through. For example, the optical switch 108A may allow optical signals that are traversing the first ODN to and/or from the OLT 102A to proceed through the optical switch 108A. In the off state, the optical switch 108A may block optical signals that are traversing the first ODN to and/or from the OLT 102A. In some cases, the OLT 102A may generate and transmit control signals that control the state of the optical switches 108A-B, and/or the OLT 102B may generate and transmit control signals that control the state of the optical switches 108C-D. In other cases, the ME 103 may generate and transmit control signals that control the state of the optical switches 108A-D. The optical switches 108A-D may include, or may be coupled to, processors that process the control signals and set the optical switches 108A-D to the on state or the off state based on the control signals.

Although in FIG. 1 the OLTs 102A-B are each associated (e.g., have an established connection) with a respective N number of ONUs, the respective number of ONUs associated with each OLT may be different from one another. In some cases, the number of ONUs associated with an OLT at any given point in time may be equal to or less than the maximum number of connections supported by the splitters 112A-B. For example, the splitter 112A may be a 2×N optical splitter that facilitates optical communication with a maximum of two OLTs (e.g., the OLTs 102A-B) and a maximum of N ONUs (e.g., the ONUs 114A-D). In a case that there are fewer than two OLTs and/or fewer than N ONUs connected to the splitter 112A, additional OLTs (e.g., up to two) and/or ONUs (e.g., up to N) may be connected to the splitter 112A in the future. Once connected to the splitter 112A, the ONUs may register with an OLT (e.g., the OLT 102A) during a discovery procedure. The splitter 112B may also be a 2×N splitter. In some cases, the splitter 112A and the splitter 112B does not support the same number of OLTs and/or ONUs.

The OLT 102A may be utilized to service (e.g., transmit grants to) the ONUs 114A-D via the first ODN when the optical switch 108A is in an on state and may be utilized to serve the ONUs 124A-D via the second ODN when the optical switch 108B is in an on state. When the optical switch 108A is in an off state, the ONUs 114A-D may be served by the OLT 102B via the third ODN. The OLT 102B may be utilized to service the ONUs 124A-D via the fourth ODN when the optical switch 108D is in an on state and may be utilized to serve the ONUs 114A-D via the third ODN when the optical switch 108C is in an on state. When the optical switch 108D is in an off state, the ONUs 124A-D may be served by the OLT 102A via the second ODN.

In one or more implementations, the subject technology may be implemented at the OLTs 102A-B to facilitate shared protection in the network environment 100. In this regard, the OLTs 102A-B may be utilized in a shared protection scheme. The OLT 102A is assigned (e.g., by the ME 103) as the primary OLT for the ONUs 114A-D and the backup our for the ONUs 124A-D. The OLT 102B is assigned (e.g., by the ME 103) as the primary OLT for the ONUs 124A-D and the backup OLT for the ONUs 114A-D.

During operation of the OLT 102A in its normal operation mode, the OLT 102A is utilized as the working OLT to serve the ONUs 114A-D, whereas the OLT 102B is a standby OLT with respect to the ONUs 114A-D. In the normal operation mode, the optical switch 108A is in an on state to allow optical signals to be exchanged between the OLT 102A and the ONUs 114A-D, and the optical switch 108B is in an of state. During operation of the OLT 102A in its protection operation mode, the OLT 102A is utilized as the working OLT to serve the ONUs 114A-D as well as utilized as the working OLT to serve the ONUs 124A-D, whereas the OLT 102B is a standby OLT with respect to the ONUs 114A-D and 124A-D. The OLT 102A may serve the ONUs 114A-D and 124A-D via a single optical network port, with both of the optical switches 108A-B being in the on state. Thus, in transitioning from the normal operation mode to the protection operation mode, the OLT 102A is transitioned to become the working OLT of the ONUs 124A-D while remaining the working OLT of the ONUs 114A-D.

During operation of the OLT 102B in its normal operation mode, the OLT 102B is utilized as the working OLT to serve the ONUs 124A-D, whereas the OLT 102A is a standby OLT with respect to the ONUs 124A-D. In the normal operation mode, the optical switch 108D is in an on state to allow optical signals to be exchanged between the OLT 102B and the ONUs 124A-D, and the optical switch 108C is in an off state. During operation of the OLT 10213 in its protection operation mode, the OLT 102B is utilized as the working OLT to serve the ONUs 124A-D as well as utilized as the working OLT to serve the ONUs 114A-D, whereas the OLT 102A is a standby OLT with respect to the ONUs 114A-D and 124A-D. The OLT 102B may serve the ONUs 114A-D and 124A-D via a single optical network port, with both of the optical switches 108A-B being in the on state. Thus, in transitioning from the normal operation mode to the protection operation mode, the OLT 102B is transitioned to become the working OLT of the ONUs 114A-D while remaining the working OLT of the ONUs 124A-D.

In one or more implementations, the primary OLT (e.g., the OLT 102A) of a set of ONUs (e.g., the ONUs 114A-D) and the backup OLT (e.g., the OLT 102B) of the set of ONUs utilize conduits, which may contain multiple optical waveguides, that are physically separate from one another. For example, the optical fibers utilized by the primary OLT and the backup OLT are not located within the same conduit. The physical separation of the optical waveguides may help avoid the situation in which damage to one conduit affects communication of both the primary OLT and the backup OLT of the set of ONUs.

In FIG. 1, a protection event may occur when one of OLTs 102A-B or an associated ODN fails, in which case the shared protection scheme is implemented. An OLT and/or an ODN may fail when one or more components of the OLT and/or the ODN (e.g., OLT, conduit, optical switch, splitter) is not functioning properly and/or damaged. As one example, the our 102A may fail when a transmitter of the OLT 102A cannot turn on and/or off properly (e.g., the transmitter cannot be turned off). As another example, the first ODN may fail when the conduit 110A is severed. In one or more implementations, FIG. 1 illustrates the case when the OLTs 102A-B are each operating in the normal operation mode. The optical switches 108A and 108D are in an on state and the optical switches 108B-C are in an off state.

During operation of the OLT 102B in the normal operation mode, the OLT 102B may be utilized to serve the ONUs 124A-D and not serve the ONUs 114A-D. The OLT 102B is the working OLT of the ONUs 124A-D and a standby OLT of the ONUs 114A-D. Communication in the downstream direction (e.g., from the OLT 102B to the ONUs 124A-D) may be broadcast such that the ONUs 124A-D receive the same downstream signal from the OLT 102B. In some cases, to serve the ONUs 124A-D, the OLT 102B may allocate resources through a time division multiplexing (TDM) scheme to allow data traffic flow in the upstream direction (e.g., from the ONUs 124A-D to the OLT 102B) in accordance with the resource allocation.

For example, the OLT 102B may transmit grant messages (e.g., grant GATE messages) transmitted in the downstream direction to the ONUs 124A-D, with each grant message including an LLID. Each grant message may include one or more time slots to be assigned and/or granted to the ONU (e.g., one of the ONUs 124A-D) associated with the LLID included in the grant message. The time slots may be defined by a start time (e.g., based on a clock of the OLT 102B) and a length (e.g., temporal duration). The start time indicates when the ONU may start transmitting upstream data traffic over the fourth ODN and the amount of time the ONU may continue to transmit its upstream data traffic.

In some cases, the grant message may include zero time slots (e.g., no time slots) to be assigned and/or granted to the GNU associated with the LLID included in the grant message. In these cases, the OLT 102B may utilize the grant message to help maintain (e.g., keep alive) the connection between the ONU and the OLT 102B. To maintain communication between an OLT and its ONUs, the OLT may provide periodic granting of time slots for each ONU. For example, the OLT may send at least one grant message every 10 ms.

The ONUs 124A-D are each associated with at least one LLID, such as a 15-bit LLID, that is included in data packets transmitted between the ONUs 124A-D and the OLT 102B. The LLID(s) may be assigned to each of the ONUs 124A-D by the OLT 102B, such as during a discovery procedure. Thus, the ONUs 124A-D may receive all of the data traffic transmitted by the OLT 102B, and the ONUs 124A-D may determine whether they are the intended recipients of received traffic data based at least on the LLID contained in the data traffic. Each of the ONUs 124A-D may process the data traffic that is indicated for the ONU and/or its associated user device, and may drop the data traffic that is not intended for the ONU and/or its associated user device. For example, a data packet may include, or may be, the grant message. For any given grant message, the ONU associated with the LLID may process the grant message to obtain its assigned time slot(s), whereas the other ONUs, which are not associated with the LLID, may discard the grant message.

To allow registration of new ONUs, the OLT 102B may initiate the discovery procedure periodically. The OLT 102B may allot discovery time slots during which ONUs not yet registered with the OLT 102B may register with the OLT 102B. Within the discovery time slot, ONUs seeking registration with the OLT 102B may send registration request messages (e.g., REGISTER_REQ messages) to the OLT 102B. The round trip times (RTTs) associated with the ONUs may be the same or may be different from one another. In some cases, a random delay may be applied by each ONU to the transmission of the registration request message. The random delay may facilitate avoidance of collisions even in the case where the RTTs associated with two (or more) ONUs are the same. In one or more implementations, the OLT 102B may determine the RTT associated with each of the ONUs 124A-D. The time slots (e.g., the start times, time slot lengths) allocated to the ONUs 124A-D may be based on the RTTs.

In the upstream direction, the ONUs 124A-D may transmit data traffic in accordance with the TDM scheme provided in the grant messages. For example, in the data traffic flow, a first time slot may be assigned and/or granted to the ONU 124A and/or an LLID serviced by the ONU 114A, a second time slot may be assigned and/or granted to the ONU 124B and/or an LLID serviced by the ONU 124B, a third time slot is assigned and/or granted to the ONU 124C and/or an LLID serviced by the ONU 124C, and a fourth time slot may be assigned and/or granted to the ONU 114D and/or an LLID serviced by the ONU 124D. Thus, the ONU 124A transmits upstream data traffic directed to the OLT 102A over the first ODN during the first time slot, the ONU 124B transmits upstream data traffic directed to the OLT 102A over the first ODN during the second time slot, the ONU 124C transmits upstream data traffic directed to the OLT 102A over the first ODN during the third time slot and the ONU 124D transmits upstream data traffic directed to the OLT 102B over the first ODN during the fourth time slot, thereby preventing any collisions between the upstream data traffic transmitted by the ONUs 124A-D.

In some cases, the time slots for the ONUs 124A-D may be dynamically allocated based, for example, on queue status associated with the ONUs 124A-D. The queue status may be provided by the ONUs 124A-D to the OLT 102B, such as in a report message (e.g., REPORT message). The report message may contain a cumulative length of at least a subset of queued packets. In some cases, multiple cumulative lengths, each associated with a different subset of the queued packets, may be provided in the report message. A higher number of time slots and/or longer time slots may be assigned and/or granted to the ONUs 124A-D with more data traffic buffered in their queue(s). The report message may be sent at an end of a time slot.

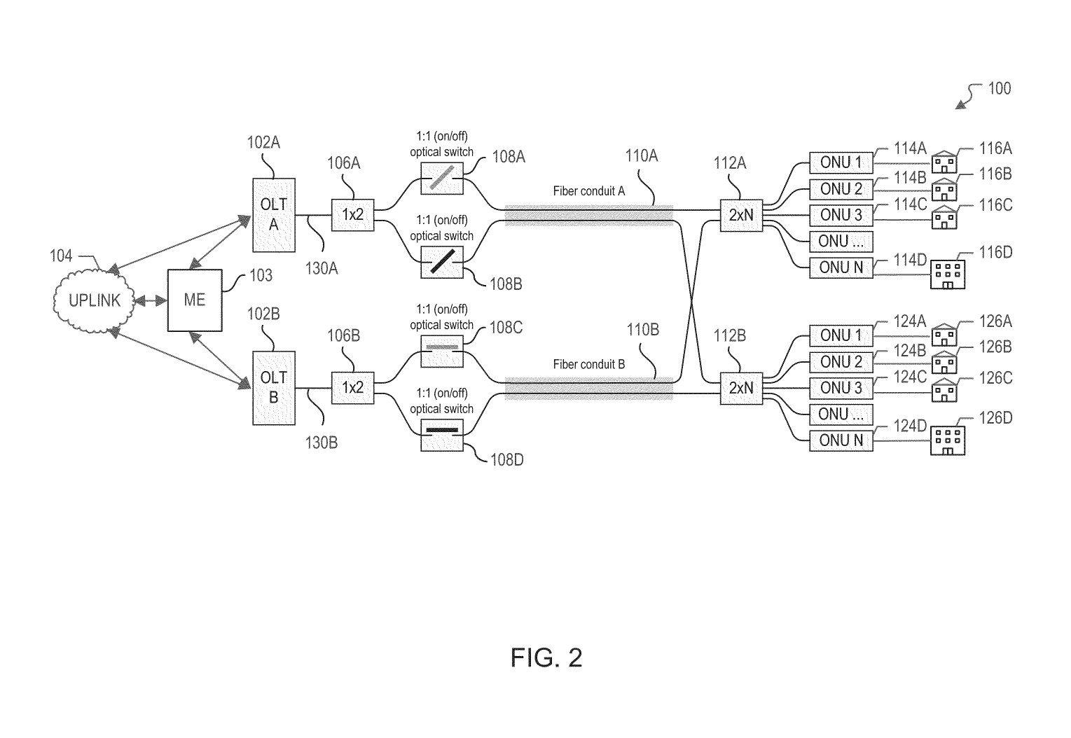

FIG. 2 illustrates an example of the network environment 100 in which a system for shared protection in an optical network may be implemented in accordance with one or more implementations. Not all of the depicted components may be used, however, and one or more implementations may include additional components not shown in the figure. Variations in the arrangement and types of the components may be made without departing from the spirit or scope of the claims as set forth herein. Additional, different, or fewer components may be provided.

The description from FIG. 1 generally applies to FIG. 2, with examples of differences between FIG. 1 and FIG. 2 and other description provided herein for explanatory purposes of clarity and simplicity. In one or more implementations, FIG. 2 illustrates the case when the OLT 102A is unavailable to serve its ONUs 114A-D and the OLT 102B is operating in the protection operation mode to be utilized as the working OLT of the ONUs 114A-D and 124A-D. The OLT 102B may serve the ONUs 114A-D and 124A-D via a single optical network port. The optical switches 108C-D are each in an on state and the optical switches 108A-B are each in an off state.

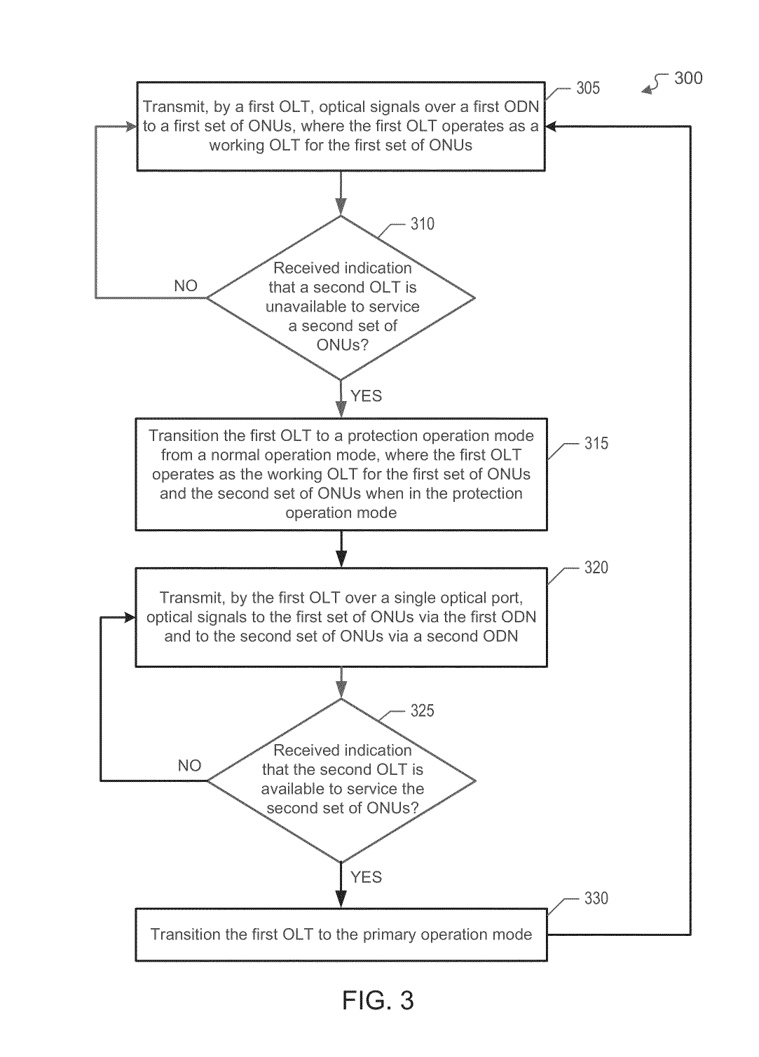

FIG. 3 illustrates a flow diagram of an example process 300 of an OLT in a system for shared protection in accordance with one or more implementations. For explanatory purposes, the example process 300 is described herein with reference to the OLT 102B of the example network environment 100 of FIGS. 1 and 2; however, the example process 300 is not limited to the OLT 102B of the example network environment 100 of FIG. 1. For example, the example process 300 may be performed by the OLT 102B when the OLT 102B needs to be utilized as a working OLT to serve a set of ONUs (e.g., the ONUs 114A-D) when the primary OLT (e.g., the OLT 102A) of the set of ONUs is unavailable to serve the set of ONUs. In another example, the example process 300 may be performed by the OLT 102A when the OLT 102A needs to be utilized as a working OLT to serve a set of ONUs when the primary OLT (e.g., the OLT 102B) of the set of ONUs is unavailable to serve the set of ONUs.

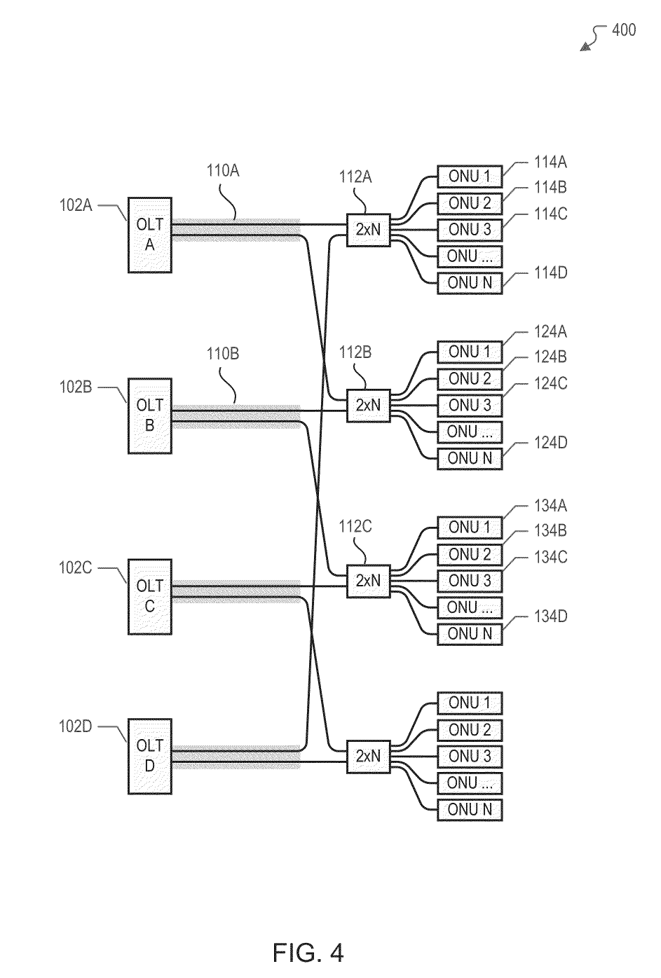

Furthermore, the example process 300 may be performed by the OLTs 102A-D in the example optical network environment 400 of FIG. 4. The blocks of example process 300 are described herein as occurring in serial, or linearly. However, multiple blocks of example process 300 may occur in parallel. In addition, the blocks of example process 300 need not be performed in the order shown and/or one or more of the blocks of example process 300 need not be performed.

During operation of the OLT 102B in the normal operation mode, the OLT 102B may be utilized to serve the ONUs 124A-D and not serve the ONUs 114A-D. The OLT 102B is the working OLT of the ONUs 124A-D and a standby our of the ONUs 114A-D. The OLT 102B may transmit optical signals over the fourth ODN to the ONUs 124A-D (305). Communication of the optical signals in the downstream direction (e.g., from the OLT 10213 to the ONUs 124A-D) may be broadcast such that the ONUs 124A-D receive the same downstream signals from the OLT 102B. In this regard, the ONUs 124A-D receive downstream optical signals with the same information content as, but reduced power level from, the downstream optical signals transmitted by the OLT 102B. The optical signals may be grant messages (e.g., grant GATE messages) transmitted in the downstream direction to the ONUs 124A-D. Each grant message may include an LLID and one or more time slots to be assigned and/or granted to the ONU (e.g., one of the ONUs 124A-D) associated with the LLID.

The OLT 102B may receive an indication that the OLT 102A is unavailable to service the ONUs 114A-D (310), where the ONUs 114A-D are serviced by the OLT 102A when the OLT 102A is operating in the normal operation mode. The indication may be utilized as a control signal to cause the OLT 102B to switch/transition to the protection operation mode from the normal operation mode upon receipt of the indication. The OLT 102B may continue to operate in the normal operation mode until such indication is received.

The OLT 102A may be unavailable to service the ONUs 114A-D when the OLT 102A and/or one or more components of the first ODN (e.g., the conduit 110A, the splitter 106A, etc.) fail. In this regard, the OLT 102A is a standby OLT of the ONUs 114A-D and 124A-D. The OLT 102A may fail when circuitry within or otherwise associated with the OLT 102A operate incorrectly and/or cannot operate. The OLT 102A may fail when a transmitter (e.g., a laser) of the OLT 102A is unable to be properly turned off (e.g., stuck on high). The first ODN may fail when the conduit 110A and/or an optical fiber within the conduit 110A are damaged (e.g., severed). The foregoing provides non-limiting examples that may cause the OLT 102A to be unavailable; other causes are possible.

In some cases, the indication may be generated by the OLT 102A. For example, the OLTs 102A-B may monitor optical signals in their respective ODNs. When the OLT 102A and/or first ODN fail, the OLT 102A may detect the failure and generate a control signal to the OLT 102B to cause the OLT 102B to provide protection to the ONUs 114A-D previously served by the OLT 102A. In some cases, controller/monitoring device(s) (not shown) may monitor optical signals in the various ODNs. The ME 103 may include, may be, may be part of, or may be in communication with the controller/monitoring device(s).

In some cases, the ME 103 may generate the indication based on receiving information from the OLT 102A and/or the controller/monitoring device(s) indicative of failure of the our 102A and/or the first ODN. The indication may be transmitted from the OLT 102A to the ME 103 and relayed by the ME 103 to the OLT 102B, transmitted directly between the OLT 102A and the OLT 102B, and/or transmitted by the ME 103 to the OLT 102B without direct input from the OLT 102A.

The OLT 102B may transition into the protection operation mode from the normal operation mode in response to receiving the indication (315). In the transition, the OLT 102B becomes the working OLT of the ONUs 114A-D while remaining as the working OLT of the ONUs 124A-D. In one or more implementations, as part of the transition, the OLT 102B determines resource allocation information for each ONU of the ONUs 114A-D and 124A-D. When the OLT 102A and/or the first ODN fail, the OLT 102B may allow any scheduled transmissions granted by the OLT 102B to the ONUs 124A-D to be completed prior to transitioning to the protection operation mode, e.g., servicing (e.g., providing grants to) the ONUs 114A-D and/or initiating the discovery procedure to discover the ONUs 114A-D.

Since the number of ONUs serviced by the OLT 102B increases when the OLT 102B is operating in the protection operation mode, the OLT 102B may adjust its TDM scheme when the OLT 102B is being utilized as the working OLT for the ONUs 114A-D and 124A-D. The OLT 102B may assign and/or grant time slots to the ONUs 114A-D and/or LLIDs serviced by the ONUs 114A-D as well as the ONUs 124A-D and/or LLIDs serviced by the ONU 124A-D. In some cases, the number and/or duration of the time slots that may be assigned and/or granted to the ONUs 114A-D and 124A-D may be fewer and/or shorter than time slots that are assigned and/or granted to the ONUs 124A-D when the OLT 102B is operating in the normal operation mode. Alternatively or in addition, the intervals between grants to the same ONU (e.g., the ONU 114A) may increase to accommodate additional grants within these intervals.

In some cases, when the OLT 102B is operating in the protection operation triode, higher priority services for the ONUs 114A-D and 124A-D may be preserved whereas lower priority services may be operated under constrained capacity. Higher priority services may include, for example, security-related services, audio services (e.g., phone services), video streaming services, among others. Lower priority services may include, for example, best effort services such as those associated with web browsing, email, and file transfer applications.

In one or more implementations, as part of the transition, to allow the OLT 102B to protect the ONUs 114A-D, the OLT 102B and/or the ME 103 generates control signals that cause the optical switches 108C-D to be in an on state. As an example, the control signals may be provided to the optical switches 108A-D and processed by the optical switches 108A-D. As another example, the control signals may be provided to one or more actuators/controllers (not shown) that may in turn cause the optical switches 108A-D to be in the desired states. FIG. 2 illustrates an example of a combination of the states for the optical switches 108A-D when the OLT 102B is operating in the protection operation mode. In some aspects, setting the optical switches 108A-B the off state helps mitigate the case that a transmitter (e.g., a laser) of the OLT 102A is unable to properly turn off (e.g., stuck on high).

In one or more implementations, the OLT 102A and/or the ME 103 provide configuration data associated with the ONUs 114A-D to the OLT 102B. The providing of the configuration data may be prior to a failure in the OLT 102A and/or the first ODN to facilitate expediting of the transition from the normal operation mode to the protection operation mode. With the configuration information, in some cases, the OLT 102B may bypass the discovery procedure with regard to the ONUs 114A-D and proceed to granting the ONUs 114A-D upon transitioning of the OLT 102B to the protection operation mode. The configuration data may be transmitted directly between the OLT 102A and the OLT 102B. Alternatively or in addition, the configuration data may be sent between the OLT 102A and the OLT 102B by way of the ME 103. The configuration data may include RTT between the OLT 102A and the ONUs 114A-D and/or LLIDs assigned to the ONUs 114A-D (e.g., by the OLT 102A or the ME 103). When the OLT 102A and/or the first ODN fail, the OLT 102B utilizes the LLIDs assigned to the ONUs 114A-D.

In some aspects, the OLT 102B does not have configuration data associated with the ONUs 114A-D. To allow the OLT 102B to service the ONUs 114A-D, the OLT 102B may initiate a discovery procedure to allow the ONUs 124A-D to register with the OLT 102A upon transitioning of the OLT 102B to the protection operation mode. The optical switches 108A-B may be switched on to allow a discovery message (e.g., discovery GATE message) to be transmitted (e.g., broadcasted) to the ONUs 114A-D and the ONUs 124A-D. The discovery message may utilize a broadcast LLID that may be processed by the ONUs 114A-D and the ONUs 124A-D. At the conclusion of the discovery procedure, the OLT 102B (or the ME 103) assigns at least one LLID to each of the ONUs 124A-D. In some cases, the OLT 102B (or the ME 103) may reassign new LLIDs to the ONUs 124A-D regardless of whether the OLT 102B has data associated with LLIDs previously assigned to the ONUs 114A-D (e.g., by the our 102A or the ME 103).

The OLT 102B may determine the RTT associated with communication between the OLT 102B and the ONUs 114A-D. The RIFT may be utilized to determine the time slots to be assigned and/or granted to the ONUs 114A-D and the ONUs 124A-D. For example, the OLT 102B may determine the RTT based on the RTT associated with communication between the OLT 102A and the ONUs 114A-D (e.g., received by the OLT 102B from the OLT 102A and/or the ME 103) and an RTT associated with communication between the OLT 102B and one of the ONUs 114A-D. The RTT associated with communication between the OLT 102B and the single ONU may be determined based on an exchange between the OLT 102B and the single ONU. For example, the exchange may include a discovery message from the OLT 102B to the ONUs 114A-D and a registration request message sent by the ONUs 114A-D in response to the discovery message. The OLT 102B may determine a difference between the RTT associated with the communication of the OLT 102A and the single ONU and the RTT associated with the communication of the OLT 102B and the single ONU. The difference may be utilized to determine the RTTs associated with communication between the OLT 102B and each of the remaining ONUs.

At the ONUs 114A-D, when the OLT 102A is unavailable to service the ONUs 114A-D, the ONUs 114A-D may detect a fault condition associated with the OLT 102A and/or the first ODN. As one criterion, the ONUs 114A-D may detect the fault condition when no valid optical signal has been received within a predetermined threshold of time (e.g., 2 ms). As another criterion, the ONUs 114A-D may detect the fault condition when no grant messages have been received within a predetermined threshold of time (e.g., 50 ms). In some cases, when one or more of these criteria, among others, the ONUs 114A-D may enter a state (e.g., HOLD_OVER_STATE state) where all currently stored upstream transmission grants (e.g., grants from the OLT 102A) are purged and the transmission of data from the ONUs 114A-D to the OLT 102A is suspended. The incoming upstream data frames may be buffered by the ONUs 114A-D. The ONUs 114A-D may exit the state when a discovery message or a grant message is received from an OLT (e.g., the OLT 102A or the OLT 102B). The ONUs 114A-D may then be serviced by the OLT that sent the discover message or the grant message.

The OLT 102B may transmit optical signals over the fourth ODN to the ONUs 124A-D and over the third ODN to the ONUs 114A-D via a single optical port (320). In the protection operation mode for the OLT 102B, communication of the optical signals in the downstream direction may be broadcast such that the ONUs 114A-D and 124A-D receive the same downstream signals (e.g., same information content) from the OLT 102B. The optical signals may be grant messages transmitted in the downstream direction to the ONUs 114A-D and 124A-D. Each grant message may include an LLID and one or more time slots to be assigned and/or granted to the ONU (e.g., one of the ONUs 114A-D and 124A-D) associated with the LLID. Based on the time slots assigned and/or granted by the OLT 102B, the ONUs 114A-D and 124A-D may transmit upstream optical signals through the third ODN and fourth ODN, respectively, to the OLT 102B.

The OLT 102B may receive an indication that the OLT 102A is available to service the ONUs 114A-D (325). The OLT 102B may continue to operate in the protection operation mode until the indication that the OLT 102A is available to service the ONUs 114A-D is received by the OLT 102B. The indication may be transmitted to the OLT 102B by the OLT 102A and/or the ME 103. For example, the indication may be transmitted when the ME 103 detects that a severed conduit and/or transmitter associated with the OLT 102A has been replaced. In some cases, the OLT 102A may have been replaced. For example, a line card that included the OLT 102A may have been replaced with a new OLT that services the ONUs 114A-D. The new OLT may be provided with configuration information (e.g., by the ME 103), such as LLID(s) and RTT associated with the ONUs 114A-D.

The OLT 102B may transition into the normal operation mode from the protection operation mode in response to receiving the indication that the OLT 102A is available to service the ONUs 114A-D (330). The OLT 102B may allow any scheduled transmissions granted by the OLT 10213 to the ONUs 114A-D and 124A-D to be completed prior to transitioning to the normal operation mode.

The OLT 102B and/or the ME 103 may generate control signals that cause the optical switch 108C to be in an off state and the optical switch 108D to be in an on state. Similarly, the OLT 102A and/or the ME 103 may generate control signals that cause the optical switch 108A to be in an on state and the optical switch 108B. In some cases, the combination of the states may transition from the combination illustrated in FIG. 2 to the combination illustrated in FIG. 1.

In the transition, the OLT 102B is the working our of the ONUs 124A-D and becomes a standby OLT of the ONUs 124A-D. In one or more implementations, as part of the transition, the OLT 102B determines resource allocation information for the ONUs 124A-D, but not the ONUs 114A-D. The OLT 102A may reinstate itself as the working OLT that serves the ONUs 114A-D. To reinstate its role as the working OLT for the ONUs 114A-D, the OLT 102A may transmit grant messages to the ONUs 114A-D via the first ODN.

The OLT 102B may transmit optical signals over the fourth ODN to the ONUs 124A-D (305). The optical signals may be grant messages transmitted in the downstream direction to the ONUs 124A-D. Each grant message may include an LLID and one or more time slots to be assigned and/or granted to the ONU (e.g., one of the ONUs 124A-D) associated with the LLID. Based on the time slots assigned and/or granted by the OLT 102B, the ONUs 124A-D may transmit upstream optical signals through the fourth ODN to the OLT 102B. Similarly, the ONUs 114A-D may transmit optical signals through the first ODN to the OLT 102A in accordance with grant messages sent from the OLT 102A to the ONUs 114A-D.

FIG. 4 illustrates an example of an optical network environment 400 in accordance with one or more implementations. Not all of the depicted components may be used, however, and one or more implementations may include additional components not shown in the figure. Variations in the arrangement and types of the components may be made without departing from the spirit or scope of the claims as set forth herein. Additional, different, or fewer components may be provided.

The optical network environment 400 may allow an interleaved protection scheme. The OLT 102A may be utilized as a backup of the OLT 102B, the OLT 102B may be utilized as a backup of the OLT 102C, the OLT 102C may be utilized as a backup of an OLT 102D, and the OLT 102D may be utilized as a backup of the OLT 102A. Control signals and/or configuration data may be provided between the various OLTs 102A-D, such as directly between the OLTs 102A-D or through an intermediary device (not shown) to indicate whether one OLT needs back up from another OLT.

The description of FIGS. 1-3 generally applies to FIG. 4. For example, the splitter 106A and the optical switches 108A-B may be coupled between the OLT 102A and the conduit 110A. The OLTs 102A-D may be in communication with one or more management entities. In some cases, a single management entity (e.g., the ME 103) may be in communication with each of the OLTs 102A-D. The OLTs 102A-D may be connected to an uplink (e.g., the uplink 104). The primary OLT (e.g., the OLT 102A) of a set of ONUs (e.g., the ONUs 114A-D) may be provided with configuration information (e.g., RTT, LLID) associated with a set of ONUs (e.g., the ONUs 124A-D) for which the OLT services as the backup OLT.

Although an interleaved protection configuration is illustrated in FIG. 4, the OLTs 102A-D may utilize a different protection scheme. For example, the OLTs 102A-B may utilize the pairwise protection configuration (as shown in FIGS. 1 and 2) and the OLTs 102C-D may utilize a separate pairwise protection configuration. As another example, the OLTs 102A-C may utilize an interleaved protection configuration whereas the OLT 102D may be unprotected.

In one or more implementations, a PON chassis may include protected and unprotected OLT ports. An unprotected OLT port does not have an associated backup OLT that may service ONUs serviced by the unprotected OLT port if the unprotected our port or its associated ODN were to fail. In some aspects, the primary OLT (e.g., the OLT 102A) of a set of ONUs (e.g., the ONUs 114A-D) and the backup OLT (e.g., the OLT 102B) of the set of ONUs utilize waveguides (e.g., optical fibers) that are physically separate from one another. Although the various ODNs are illustrated as utilizing tree topologies, other topologies such as ring topologies, bus topologies, among others, may be utilized.

In one or more implementations, an OLT may serve as a backup OLT for multiple sets of ONUs. For example, although not shown in FIG. 4, the OLT 102A may serve as the primary OLT for the ONUs 114A-D as well as service as the backup OLT for the ONUs 124A-D and ONUs 134A-D. Additional interconnections (e.g., via optical fibers) may be employed between the various components to facilitate this protection scheme. A splitter 112C in FIG. 4 may be replaced with a 3×N splitter, for example, in such cases. Conversely, in one or more implementations, a set of ONUs may be backed up by multiple OLTs. For example, the ONUs 134A-D may be serviced by the OLT 102B (its primary OLT) or by one of the OLTs 102B-C (its backup OLTs) when the primary OLT is unavailable to service the ONUs 134A-D. The backup OLT to be utilized may be based on, for example, whether the backup OLT is functioning properly and/or amount of data traffic associated with the backup OLTs. For a protection scheme in which a set of ONUs is backed up by M OLTs, the splitter connected to the ONUs, e.g., the splitter 112C, may be replaced with an M×N splitter.

In one or more implementations, multiple OLT ports may be on a common line card. The common line card may provide centralized management (e.g., via the ME 103) of the OLT ports. In some aspects, the primary OLT does not share the same line card as the backup OLT for the ONUs (e.g., since a general solution to a failing OLT port is to replace the entire line card).

In one or more implementations, the subject technology allows protection capacity to grow automatically as new optical fibers are connected and/or new line cards are added. In some cases, each OLT is pre-populated with configuration data for the ONUs to which the OLT serves as the backup OLT. The pre-population may be performed in advance to facilitate minimization of switching time (e.g., transition from the normal operation mode to the protection operation mode).

Although the foregoing describes grants from OLTs that allocate resources to ONUs in accordance with a TDM scheme, a wavelength division multiplexing (WDM) scheme may be employed alternative to or in addition to the TDM scheme. For example, the grant message from an OLT (e.g., the OLT 102A) to its associated ONUs (e.g., the ONUs 114A-D) may include information associated with resource allocation. For a given grant message, the information in the grant message may include one or more time slots (e.g., the TDM scheme) and/or wavelength allocation (e.g., the WDM scheme) to be utilized by an ONU (e.g., the GNU 114A). The wavelength allocation by the OLT indicates the wavelength of optical signals to be utilized by a transmitter of the ONU. Each ONU served by the OLT may be allocated a different wavelength.

In one or more implementations, the subject technology allows protection of OLTs, and their associated ONUs, without use of dedicated protection OLTs. The dedicated protection OLTs may remain idle (e.g., not service any ONUs) until OLTs backed up by the dedicated protection OLTs fail. For example, one dedicated protection OLT may be utilized to protect N OLTs. When one of the N OLTs is unable to function, the dedicated protection OLT may utilize an N×1 optical switch to allow optical communication between the dedicated protection OLT and ONUs associated with the malfunctioning OLT and block optical communication between the dedicated protection OLT and ONUs associated with the remaining OLTs. In general, the N×1 optical switch may be slower and/or more expensive than N 1×1 optical switches.

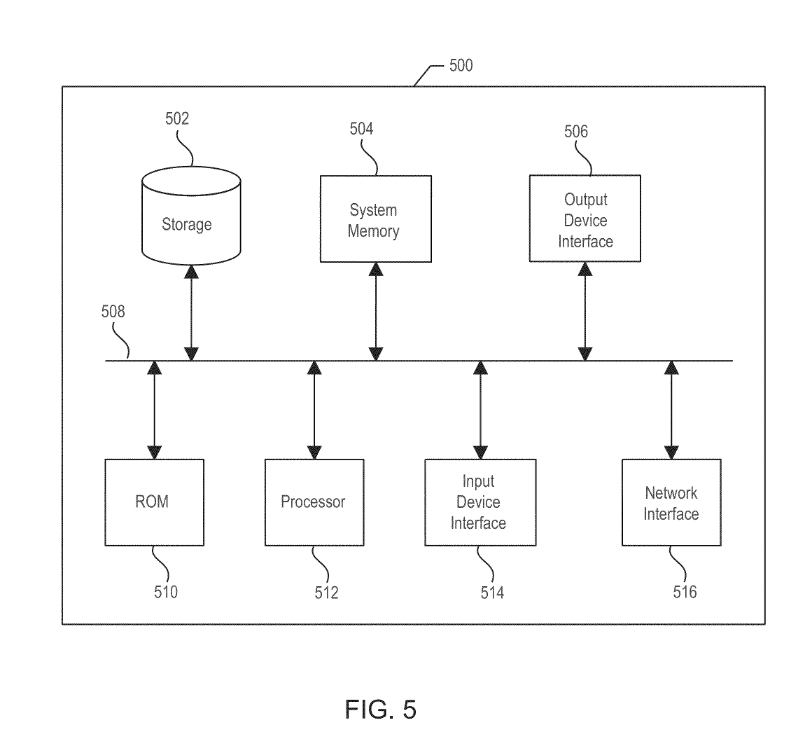

FIG. 5 conceptually illustrates an example of an electronic system 500 with which one or more implementations of the subject technology can be implemented. The electronic system 500, for example, may be, or may include, the OLTs 102A-D, one or more of the ONUs 114A-D and 124A-D, and/or one or more electronic devices associated with the customer premises equipment 116A-D and 126A-D, such as a desktop computer, a laptop computer, a tablet computer, a phone, and/or generally any electronic device. Such an electronic system 500 includes various types of computer readable media and interfaces for various other types of computer readable media. The electronic system 500 includes a bus 508, one or more processing unit(s) 512, a system memory 504, a read-only memory (ROM) 510, a permanent storage device 502, an input device interface 514, an output device interface 506, one or more network interface(s) 516, and/or subsets and variations thereof.

The bus 508 collectively represents all system, peripheral, and chipset buses that communicatively connect the numerous internal devices of the electronic system 500. In one or more implementations, the bus 508 communicatively connects the one or more processing unit(s) 512 with the ROM 510, the system memory 504, and the permanent storage device 502 From these various memory units, the one or more processing unit(s) 512 retrieves instructions to execute and data to process in order to execute the processes of the subject disclosure. The one or more processing unit(s) 512 can be a single processor or a multi-core processor in different implementations.

The ROM 510 stores static data and instructions that are utilized by the one or more processing unit(s) 512 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a floppy disk, flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random access memory (RAM). The system memory 504 may store one or more of the instructions and/or data that the one or more processing unit(s) 512 may utilize at runtime. In one or more implementations, the processes of the subject disclosure are stored in the system memory 504, the permanent storage device 502, and/or the ROM 510. From these various memory units, the one or more processing unit(s) 512 retrieve instructions to execute and data to process in order to execute the processes of one or more implementations.

The bus 508 also connects to the input and output device interfaces 514 and 506. The input device interface 514 enables a user to communicate information and select commands to the electronic system 500. Input devices that may be used with the input device interface 514 may include, for example, alphanumeric keyboards and pointing devices (also called “cursor control devices”). The output device interface 506 may enable, for example, the display of images generated by the electronic system 500. Output devices that may be used with the output device interface 506 may include, for example, printers and display devices, such as a liquid crystal display (LCD), a light emitting diode (LED) display, an organic light emitting diode (OLED) display, a flexible display, a flat panel display, a solid state display, a projector, such as a prism projector that may be included in a smart glasses device, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

As shown in FIG. 5, bus 508 also couples electronic system 500 to one or more networks (not shown) through one or more network interface(s) 516. The one or more network interface(s) may include an Ethernet interface, a WiFi interface, a Bluetooth interface, a Zigbee interface, a multimedia over coax alliance (MoCA) interface, a reduced gigabit media independent interface (RGMII), or generally any interface for connecting to a network. In this manner, electronic system 500 can be a part of one or more networks of computers (such as a local area network (LAN), a wide area network (WAN), or an Intranet, or a network of networks, such as the Internet. Any or all components of electronic system 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (e.g., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A device, comprising:
at least one processor circuit configured to:
transmit first optical signals over an optical network port to a first set of optical network units (ONUs) via a first optical distribution network (ODN), wherein the device operates as a working optical line terminal (OLT) for the first set of ONUs;
receive a first indication that an optical line terminal (OLT) is unavailable to service a second set of ONUs;
transition to a protection operation mode from a normal operation mode in response to receiving the first indication, wherein the device operates as the working OLT for the first set of ONUs and the second set of ONUs when in the protection operation mode; and
transmit second optical signals over the optical network port to the first set of ONUs via the first ODN and to the second set of ONUs via a second ODN, the second optical signals comprising resource allocation information for at least some of the first set of ONUs and the second set of ONUs.

2. The device of claim 1, wherein the at least one processor circuit is further configured to:
receive a second indication that the OLT is available to service the second set of ONUs; and
transition to the normal operation mode in response to receiving the second indication.

3. The device of claim 1, wherein, when the device is in the normal operation mode, the at least one processor circuit is configured to determine resource allocation information only for the first set of ONUs.

4. The device of claim 1, wherein the at least one processor circuit is configured to determine resource allocation information for the second set of ONUs only when the device is in the protection operation mode.

5. The device of claim 1, wherein:
the at least one processor circuit is further configured to retrieve at least one logical link identifier (LLID) for each ONU of the second set of ONUs, and
at least one of the second optical signals comprises an LLID associated with one of the ONUs of the second set of ONUs.

6. The device of claim 1, wherein the at least one processor circuit is further configured to generate a control signal to cause a switch of the second ODN to be set in an on state, wherein the switch is configured to route the second optical signals to the second set of ONUs when the switch is in the on state.

7. The device of claim 1, wherein:
the first ODN comprises:
a first splitter, wherein the device is configured to be coupled to the first splitter;
a first optical switch configured to allow communication with the first splitter; and
a second splitter configured to allow communication with the first optical switch and the first set of ONUs; and
the second ODN comprises:
the first splitter;
a second optical switch configured to allow communication with the first splitter; and
a third splitter configured to allow communication with the second optical switch and the second set of ONUs.

8. The device of claim 1, wherein the optical network port is coupled to the first ODN and the second ODN via a splitter shared by the first ODN and the second ODN.

9. A method comprising:
transmitting, by a first optical line terminal (OLT) over an optical network port, first optical signals to a first set of optical network units (ONUs) via a first optical distribution network (ODN), wherein the first OLT operates as a working OLT for the first set of ONUs;
receiving a first indication that a second OLT is unavailable to service a second set of ONUs;
transitioning the first OLT to a protection operation mode from a normal operation mode in response to receiving the first indication, wherein the first OLT operates as the working OLT for the first set of ONUs and the second set of ONUs when in the protection operation mode;
transmitting, by the first OLT over the optical network port, second optical signals to the first set of ONUs via the first ODN and to the second set of ONUs via a second ODN;
receiving a second indication that the second OLT is available to service the second set of ONUs;
transitioning the first OLT to the normal operation mode in response to receiving the second indication; and
transmitting, by the first OLT over the optical network port, third optical signals to the first set of ONUs via the first ODN.

10. The method of claim 9, wherein:
the transitioning the first OLT to the protection operation mode comprises determining resource allocation information for each ONU of the first set of ONUs and the second set of ONUs, and
the second optical signals comprise the determined resource allocation information.

11. The method of claim 9, wherein the transitioning the first OLT to the protection operation mode comprises generating a control signal to cause a switch of the second ODN to be set to an on state.

12. The method of claim 11, wherein the switch, when in the on state, routes the second optical signals to the second set of ONUs via the second ODN.

13. The method of claim 9, further comprising retrieving at least one logical link identifier (LLID) for each ONU of the second set of ONUs, wherein at least one of the second optical signals comprises an LLID associated with one of the ONUs of the second set of ONUs.

14. The method of claim 9, wherein the transitioning the first OLT to the protection operation mode comprises:
transmitting a discovery message to the second set of ONUs;
receiving a respective registration request message from at least one ONU of the second set of ONUs; and
registering the at least one ONU in response to receiving the respective registration request message.

15. The method of claim 9, further comprising:
determining resource allocation information for the second set of ONUs only when the first OLT is in the protection operation mode.

16. The method of claim 9, further comprising:
receiving fourth optical signals from at least one ONU of the second set of ONUs only when the first OLT is in the protection operation mode.

17. The method of claim 9, wherein:
transmitting the first optical signals comprises broadcasting the first optical signals to the first set of ONUs, the first optical signals comprising information associated with a first resource allocation for each ONU of the first set of ONUs;
transmitting the second optical signals comprises broadcasting the second optical signals to the first set of ONUs and the second set of ONUs, the second optical signals comprising information associated with a second resource allocation for each ONU of the first set of ONUs and the second set of ONUs; and
transmitting the third optical signals comprises broadcasting the third optical signals to the first set of ONUs, the third optical signals comprising information associated with a third resource allocation for each ONU of the first set of ONUs.

18. A computer program product comprising instructions stored in a tangible computer-readable storage medium, the instructions comprising:
instructions to transmit, by a first optical line terminal (OLT), first optical signals over an optical network port to a first set of optical network units (ONUs) via a first optical distribution network (ODN), wherein the first OLT operates as a working OLT for the first set of ONUs;
instructions to transition to a protection operation mode from a normal operation mode when a second OLT is unavailable to service a second set of ONUs, wherein the first OLT operates as the working OLT for the first set of ONUs and the second set of ONUs when in the protection operation mode; and
instructions to transmit second optical signals over the optical network port to the first set of ONUs via the first ODN and over the optical network port to the second set of ONUs via a second ODN, the second optical signals comprising resource allocation information for at least some of the first set of ONUs and the second set of ONUs.

19. The computer program product of claim 18, wherein the instructions further comprise instructions to transition to the normal operation mode when a third our is available to service the second set of ONUs.

20. The computer program product of claim 18, wherein the instructions to transition further comprise instructions to determine resource allocation information for the second set of ONUs only when the first OLT is in the protection operation mode
